(19) United States
(12) Patent Application Publication
(10) Pub. No.: US 2026/0260521 A1
(43) Pub. Date: Sep. 3, 2026

(54) SYSTEM AND METHOD FOR CELLULAR NETWORK BASED VEHICLE TOLL AND TAX DEDUCTION

(71) Applicant: JIO PLATFORMS LIMITED, Ahmedabad (IN)

(72) Inventors: Ranjit Ma KUMAR, Jabalpur (IN); Pravin Sahebrao UBALE, Buldana (IN); Kumar RAHUL, Kolkata (IN); Dhananjay PATHAK, Faizabad (IN); Kazim Hanif MARUF, Navi Mumbai (IN)

(73) Assignee: JIO PLATFORMS LIMITED, Ahmedabad (IN)

(21) Appl. No.: 18/879,980

(22) PCT Filed: Jun. 30, 2023
(86) PCT No.: PCT/IB2023/056828

§ 371 Date: Dec. 30, 2024

(30) Foreign Application Priority Data
Jun. 30, 2022 (IN) 202221037832

(51) Int. Cl. G07B 15/06; G06Q 20/10; H04W 4/021

(52) U.S. Cl. CPC G07B 15/063; G06Q 20/10; H04W 4/021; G06Q 2240/00

(57) ABSTRACT

The present disclosure relates to a system and a method for automated vehicle toll and tax collection. The method for automatically collecting the toll fee for the vehicle includes creating a geo-fence with a pre-defined radius around a toll station, authenticating the vehicle based on the vehicle moving towards the geo-fence from a first side of the toll station, allowing the vehicle to enter the geo-fence from the first side of the toll station based on the successful authentication of the vehicle, and deducting a toll fee automatically based on the vehicle exiting the geo-fence from a second side of the toll station.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to vehicular toll and tax deduction system, and more particularly, to a cellular network based automated vehicular toll and tax deduction system and method thereof.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Automotive sectors are undergoing tremendous transformation in terms of digitalization and advanced communication. For many of its applications, the automotive sector is working along with various other communication network technologies such as long-term evolution (LTE) networks and Internet of Things (IoT) network to bring such transformation.

One such application is in vehicular toll tax and toll fee collection. Conventional way of collecting toll fee involves setting up toll booths, where vehicles may have to stop and the driver of the vehicle may have to manually pay the toll in cash or with a card. To reduce human intervention, automated systems are engaged to collect the toll fee by equipping vehicles with a Radio-Frequency Identification (RFID) tag that may be scanned by a toll reader device installed at the toll booths.

In the existing RFID-based toll collection system, the RFID tags are installed on a wind shield of the vehicle or on an outer side of the wind shield. This creates high probability for the tags to get stolen. Such stolen tags may also be misused. Since the tags are placed outside, they may also be damaged or lost. In all the cases, the owner of the vehicle may have to either replace or lodge a complaint to get a new tag, leading to a lot of hassle.

There is, therefore, a need in the art to provide a system and a method that can overcome the shortcomings of the existing prior arts.

### SUMMARY

This section is provided to introduce certain objects and aspects of the present disclosure in a simplified form that are further described below in the detailed description. This summary is not intended to identify the key features or the scope of the claimed subject matter.

In one aspect, the present disclosure relates to an automated system for vehicle toll and tax deduction. The system includes one or more processors and a memory operatively coupled to the one or more processors, wherein the memory includes processor-executable instructions, which on execution, cause the one or more processors to create a geo-fence with a pre-defined radius around a toll station, authenticate a vehicle based on the vehicle moving towards the geo-fence from a first side of the toll station, allow the vehicle to enter the geo-fence from the first side of the toll station based on a successful authentication of the vehicle, and automatically deduct a toll fee based on the vehicle exiting the geo-fence from a second side of the toll station.

In some embodiments, the one or more processors may be configured to obtain data from an on-board diagnostic (OBD) device connected to the vehicle for communicating with a cellular network access point and a global positioning system (GPS) network, detection, and authentication of the vehicle.

In some embodiments, the data obtained from the OBD device may include GPS data and the one or more processors may be configured to report the obtained GPS data to an application server to enable mapping the GPS data with data associated with the created geo-fence to generate the toll fee.

In some embodiments, the OBD device may be pre-fitted with the vehicle or may be retrofitted with the vehicle, and may include a subscriber identity module (SIM) card to enable the OBD device to communicate with the cellular network access point.

In some embodiments, the one or more processors may be configured to authenticate the vehicle based on a vehicle identification number (VIN) and an international mobile equipment identity (IMEI) number.

In some embodiments, the one or more processors may be configured to send a first alert message to a user device associated with the vehicle based on the vehicle entering the geo-fence and send a second alert message to the user device associated with the vehicle based on the vehicle exiting the geo-fence.

In some embodiments, the one or more processors may be configured to register at least one bank account associated with each vehicle from which the toll fee is deducted, deduct the toll fee from the at least one registered bank account based on the vehicle exiting the geo-fence, and send a third alert message to the user device associated with the vehicle based on deduction of the toll fee from the at least one registered account.

In another aspect, the present disclosure relates to a method for automatically deducting vehicle toll and tax. The method includes creating, by one or more processors, a geo-fence with a pre-defined radius around a toll station, authenticating, by the one or more processors, a vehicle based on the vehicle moving towards the geo-fence from a first side of the toll station, allowing, by the one or more processors, the vehicle to enter the geo-fence from the first side of the toll station, and deducting, by the one or more processors, a toll fee automatically based on the vehicle exiting the geo-fence from a second side of the toll station.

In some embodiments, the method may include obtaining, by the one or more processors, data from an OBD device attached to the vehicle for communicating with a cellular network access point and a GPS network, detection, and authentication of the vehicle.

In some embodiments, the method may include authenticating, by the one or more processors, the vehicle based on a VIN and an IMEI number.

In some embodiments, the method may include sending, by the one or more processors, a first alert message to a user device associated with the vehicle based on the vehicle entering the geo-fence and sending, by the one or more processors, a second alert message to the user device associated with the vehicle based on the vehicle exiting the geo-fence.

In some embodiments, the method may include registering, by the one or more processors, at least one bank account associated with each vehicle from which the toll fee is deducted, deducting, by the one or more processors, the toll fee from the registered bank account based on the vehicle exiting the geo-fence, and sending, by the one or more processors, a third alert message to the user device associated with the vehicle based on deducting the toll fee from the at least one registered account.

In one another aspect, the present disclosure relates to a user equipment (UE) including one or more processors communicatively coupled to a system, wherein the one or more processors are operatively coupled to a memory including processor-executable instructions, which on execution, cause the one or more processors to associate the UE with a vehicle, send a geographical location of the vehicle to the system upon turning on of an ignition of the vehicle, send a vehicle identity number to the system for authentication, receive a first message from the system, wherein the first message indicates that the vehicle entered a geo-fence associated with a toll station, receive a second message from the system, wherein the second message indicates that the vehicle exit the geo-fence, and receive a third message from the system, wherein the third message indicates deduction of a toll tax from an account registered with the vehicle.

In yet another aspect, the present disclosure relates to a non-transitory computer readable medium that includes one or more instructions stored thereupon that when executed by a processor causes the processor to create a geo fence with a pre-defined radius around a toll station, authenticate a vehicle based on the vehicle moving towards the geo fence from a first side of the toll station, allow the vehicle to enter the geo fence from a first side of the toll station based on the successful authentication of the vehicle, and deduct a toll fee automatically based on the vehicle exiting the geofence from a second side of the toll station.

### OBJECTS OF THE PRESENT DISCLOSURE

Some of the objects of the present disclosure, which at least one embodiment herein satisfies are as listed herein below.

It is an object of the present disclosure to provide a transparent process for automated toll collection using wideband Internet of Things (WB-IoT) technology.

It is another object of the present disclosure to provide a mechanism to help a regulatory authority with standardized toll collection process using on-board devices (OBD) for vehicles.

It is yet another object of the present disclosure to provide an automated location-based toll tax deduction.

It is yet another object of the present disclosure to create a geo-fence around a toll station and leverage the existing cellular networks covering a highway to assist in the automated toll fee deduction process.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates an exemplary representation of a network architecture (100-A) for automated toll and tax deduction, in accordance with an embodiment of the present disclosure.

FIG. 1B illustrates an exemplary representation (100-B) of a geo-fence created in a particular region for defining toll boundary, in accordance with an embodiment of the present disclosure.

FIG. 2 illustrates an exemplary functional architecture (200) enabling automated toll and tax deduction, in accordance with an embodiment of the present disclosure.

FIG. 3 illustrates an exemplary representation (300) of a proposed system for automated toll and tax deduction, in accordance with an embodiment of the present disclosure.

FIG. 4 illustrates an exemplary flow-chart of a method (400) for automated toll and tax deduction, in accordance with an embodiment of the present disclosure.

FIG. 5 illustrates an exemplary computer system (500) in which or with which embodiments of the present disclosure may be implemented.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “Internet of Things” may refer to a computing environment in which physical objects are embedded with devices which enable the physical objects to achieve greater value and service by exchanging data with other systems and/or other connected devices. Each physical object is uniquely identifiable through its embedded device(s) and is able to interoperate within an Internet infrastructure. The acronym “IoT,” as used herein, means “Internet of Things.”

The term “automatically” may refer to without user intervention.

The term “OBD device” may refer to on-board diagnostics device.

The term “geo fence” may refer to a virtual perimeter for a real-world geographic area. A geo-fence may be dynamically generated or matched with a predefined set of boundaries.

The present disclosure provides a robust and an effective solution for automatic toll and tax deduction. In an aspect, the present disclosure provides an IoT-based solution for automated toll and tax deduction by creating a geo-fence around a pre-defined toll deduction boundary and using the existing cellular networks, for example, without limitations, 2G/3G/4G/5G/6G or the like that may cover most of the toll highways along with an OBD device fitted on a vehicle. In some embodiments, the OBD device may be pre-fitted with the vehicle or may be retrofitted in OBD ports in the vehicles. In some embodiments, the OBD device may include a subscriber identity module (SIM) card for enabling the OBD device to attach to the cellular network and may have an ‘always on’ cellular connectivity. Further, the OBD device may include a global positioning system (GPS) client and an embedded application for reporting GPS data and a set of diagnostic data to an application server hosted on a cloud platform through the cellular network. The application server may use the reported GPS data to map with data associated with the created geo-fence to generate a toll fee. The application server may report the toll fee to end users, for example, vehicle owners or drivers through short messaging service (SMS) messages/mobile application notifications. In some embodiments, the end user may have an OBD application with a mandatory option to link to a bank account or a third-party wallet from which the toll fee may be auto debited whenever the end user crosses the geo-fence.

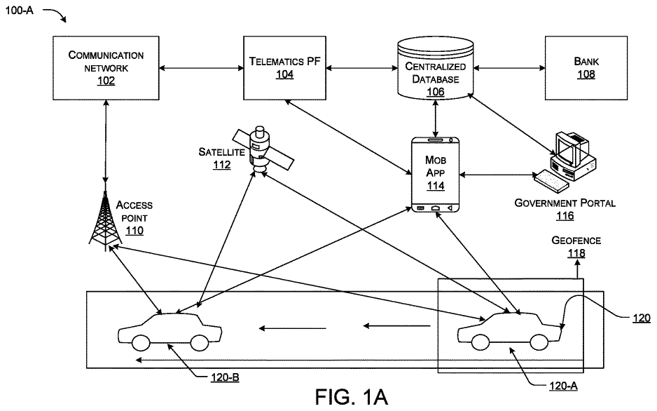

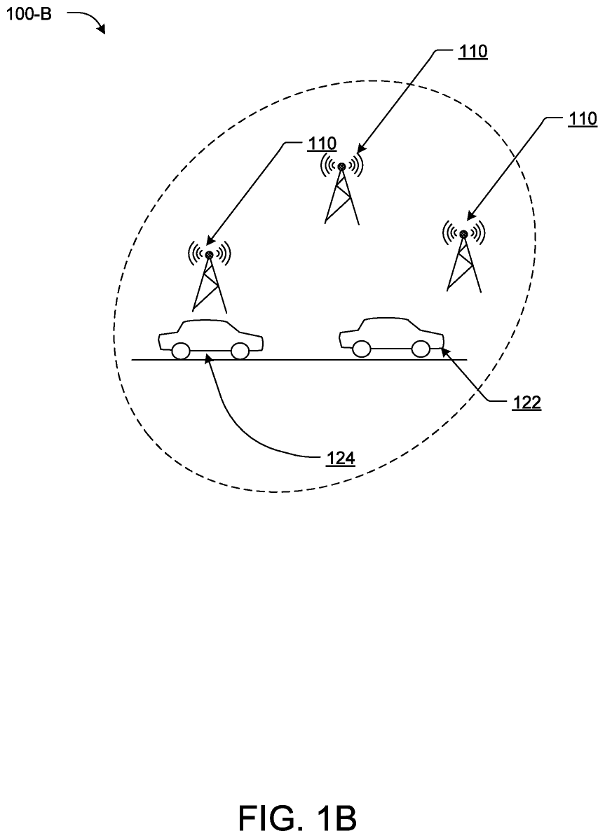

The various embodiments throughout the disclosure will be explained in more detail with reference to FIGS. 1-5.

FIG. 1A illustrates an exemplary representation of a network architecture (100-A) of an automated toll and tax deduction system, in accordance with an embodiment of the present disclosure.

Referring to FIG. 1A, the network (100-A) may include one or more network components, for example, without limitations, a communication network (102) for example, without limitations a 2G/3G/4G/5G/6G or any future communication network,, a telematics platform (104), a centralized database (106), a bank (108), an access point (110), for example, without limitations, an evolved node B or a next generation node B (gNB), or the like, a GPS satellite (112), and a government portal (116). In some embodiments, the network (100-A) may connect the one or more network components to an end user or a registered user through a mobile application (114). The end user or the registered user may be associated with a vehicle (120) whose vehicle identity number may be registered with the centralized database (106). In some embodiments, the centralized database (106) may store information related to a registered user and a vehicle associated with the registered user. The information may include, for example, without limitations, a contact number of the user, email address of the user, at least one active bank account associated with the user, etc. In some embodiments, more than one bank account associated with the registered user may be stored at the centralized database (106), so that in case if one of the bank accounts is having a lesser balance, the toll fee may be deducted from another account.

Referring to FIG. 1A, the stored information may further include details of the vehicle (120) of the registered user such as, a vehicle identity number (VIN) based on which the vehicle (120) may be authenticated when the vehicle (120) enters a geofence (118) around a toll plaza or a toll booth or a toll station or a toll collection point. The vehicle (120) may include an OBD device which may be enabled to communicate with the access point (110) and the GPS satellite (112). The communication of the vehicle's OBD device with the access point (110) may enable reading the VIN of the vehicle (120) and authenticating the vehicle (120), for allowing the vehicle (120) to enter the geofence periphery (118). In some embodiments, the OBD device in the vehicle (120) may communicate with the GPS satellite (112) to determine the location of the vehicle (120).

Referring to FIG. 1A, the OBD device may communicate the vehicle's current location with respect to the geo-fence (118). For example, the vehicle (120) may enter the geo-fence (118) at a first point (120-A) and may exit the geo-fence (118) from a second point (120-B). The first point (120-A) may be the point of the vehicle (120) entering the geo-fence (118) from a first side of a toll plaza or a toll collection point and the second point (120-B) may be the point at which the vehicle (120) may exit the geo-fence (118) from a second side of the toll plaza. The first side may be opposite to the second side. The registered user or the driver of the vehicle (120) may have a mobile application (114) in their user device to get all the required messages related to the vehicle authentication and toll deduction.

By way of example, without limitation, when the vehicle (120) is about to enter the geo-fence (118), the vehicle (120) may be authenticated based on its VIN, wherein the VIN may be stored in the centralized database (106). Further, the OBD in the vehicle (120) may communicate with the GPS satellite (112) to find the location of the vehicle (120) and communicate the same to the telematics platform (104) for VIN authentication. If the VIN is authenticated, the vehicle (120) may be allowed to enter the geo-fence (118) and a first message alert stating that the vehicle (120) has entered the geo-fence (118) may be sent to the mobile device or user device of the user/driver associated with the vehicle (120) through the access point (110). A toll fee may be calculated based on whether the vehicle (120) is in a national highway or a state highway by collecting information from the government portal (116). The calculated toll fee may be deducted from the user's registered account with the bank (108) upon exiting the geo-fence (118). Further, based on the GPS data received from the OBD, the telematics platform (104) may determine if the vehicle (120) has exit the geo-fence (118) and send a second alert message to inform the user/the driver that the vehicle (120) has exit the geo-fence (118). The toll fee may be deducted and a third alert message may be sent to the user's mobile device that the toll fee is deducted from the registered bank account. The first, second, and third alert messages may be SMS or mobile application messages. The SMS may be sent by the access point (110) to the mobile device of the user/driver. The communication network (102) may send the application message on the mobile application (114). On the other hand, if the VIN is not authenticated, the vehicle ignition may be turned off or the vehicle (120) may be prevented from entering the geo-fence (118). A toll fee associated with such vehicle may be collected using conventional technique. In some embodiments, an auto recharge option or standing instructions may be set by the user.

Referring to FIG. 1A, in some embodiments, the user may register multiple bank accounts such that if the first bank account of the user is not having enough balance, the toll fee may be debited from a second bank account. In some embodiments, an alert may be sent to the user in advance if there is less balance in the registered bank account.

FIG. 1B illustrates an exemplary representation of a geo-fence (100-B) created in a particular region for defining a toll boundary, in accordance with an embodiment of the present disclosure.

Referring to FIG. 1B, one or more access points (110) may be deployed in the geo-fence (100-B) to detect the positions (122, 124) of the vehicle (120) in the geo-fence. In some embodiments, the access points (110) may communicate with the GPS satellite system to determine the position (122, 124) of the vehicle (120) as shown in FIG. 1 inside the geo fence (100-B).

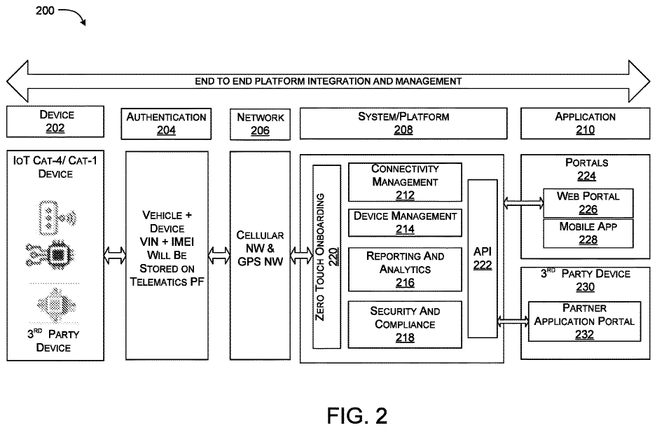

FIG. 2 illustrates an exemplary functional architecture (200) enabling automated toll and tax deduction, in accordance with an embodiment of the present disclosure.

Referring to FIG. 2, the various functional components involved in the end-to-end platform integration and management of the automated toll and tax deduction is shown. The various functional components include such as, without limitations, a device (202), an authentication device (204), network (206), a system or platform (208), and an end user application (210). Referring to FIG. 2, the device (202) may include any Category 1/Category 4 IoT device or any third party device. In some embodiments, the IoT device may include, but are not limited to, smart phones, smart watches, smart sensors (e.g., mechanical, thermal, electrical, magnetic, etc.), networked peripheral devices, communication devices, networked vehicle accessories, smart accessories, tablets, other devices for monitoring or interacting with or for users and/or places, or any combination thereof. In an embodiment, the devices (202) may include one or more of the following components: sensor, radio frequency identification (RFID) technology, GPS technology, mechanisms for real-time acquisition of data, passive or interactive interface, or any combination thereof.

Referring to FIG. 2, the authentication device (204) may perform the process of authentication for the registered vehicle. The authentication may be performed based on storing a VIN associated with the vehicle and an international mobile equipment identity (IMEI) number associated with the OBD device attached to the vehicle. The VIN and the associated IMEI may be stored on the telematics platform (104) of FIG. 1, for authentication purposes. In some embodiments, the VIN and the IMEI may be stored in the centralized database (106) of FIG. 1. Referring to FIG. 2, the OBD device may communicate with the network (206), wherein the network (206) may include a communication network and a GPS network. In an embodiment, the communication network (206) may include at least one of a 2G/3G/4G/5G/6G network, or the like. The network (206) may enable the devices (202) to communicate between devices (202) and/or with the system (208). As such, the network (206) may enable the devices (202) to communicate with other devices (202) via a wired or wireless network. The network (206) may include a wireless card or some other transceiver connection to facilitate this communication. In an exemplary embodiment, the network (206) may incorporate one or more of a plurality of standard or proprietary protocols including, but not limited to, Wi-Fi, Zigbee, or the like. In another embodiment, the network (206) may be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or the like.

Referring to FIG. 2, the network (206) may include the GPS network. A person of ordinary skill in the art will appreciate that the GPS network may refer to a network of satellites aiding in the geographical positioning of a particular device, for example, the vehicle (120) of FIG. 1.

Further, FIG. 2 illustrates a system or platform (208) for performing the various steps involved in the process of automated toll and tax deduction. The system (208) may include a connectivity management module (212), a device management module (214), a report and analytics module (216), a security and compliance module (218), a zero touch on-boarding module (220), and an application programming interface (API) (222) to connect to the application server/application module (210). In some embodiments, the connectivity module (212) may establish a connection between the vehicle system and the OBD device. In one embodiment, the OBD device may have a SIM card for attaching to the cellular network (206) and may have ‘always on’ cellular connectivity. The vehicle may include the OBD device as pre-fitted, or retro fitted with the vehicle. In some embodiments, the vehicle may be turned on if the OBD device is connected and powered ON. The system may include the device management module (214) for managing the connection associated with the OBD device and power ON/OFF the OBD device.

Referring to FIG. 2, the system (208) may include the report and analytics module (216) for reporting GPS data and diagnostics data related to the OBD device and the vehicle. In some embodiments, the OBD device may include a GPS client and an embedded application for reporting the GPS data and the required diagnostic data to the application server (210). In some embodiments, the application server (210) may be hosted on a cloud platform and the GPS client may communicate to the application server (210) through the cellular network (206). The security and compliance module (218) of the system (208) may enable authentication of the vehicle. In some embodiments, the security and compliance module (218) may also include registered bank account details and details pertaining to toll fee prescribed by the Government. The system (208) may further include the API (222) to communicate with the application server (210).

Referring to FIG. 2, the application server (210) may include portals (224) such as, without limitations, a web portal (226) and a mobile application support (228). The mobile application support (228) may provide details related to the geo-fence entry and toll fee deduction on a user application in the user's mobile device. The application server (210) may also include a third party device (230) and a partner application portal (232) associated with the third party device.

A person of ordinary skill in the art will appreciate that the exemplary functional architecture (200) may be modular and flexible to accommodate any kind of changes in the network (100) of FIG. 1.

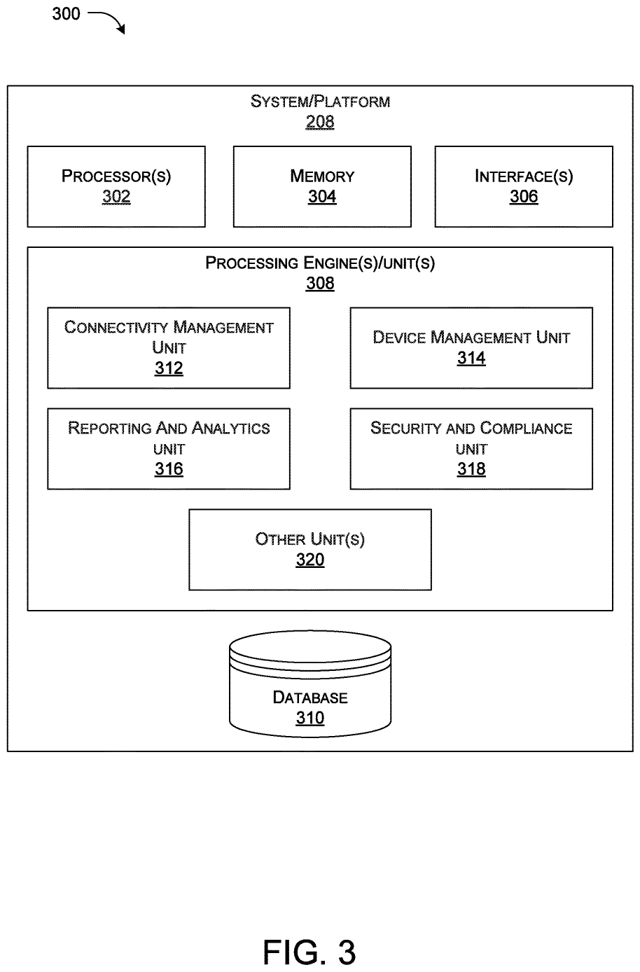

FIG. 3 illustrates an exemplary representation (300) of the proposed system for automated toll and tax deduction, in accordance with an embodiment of the present disclosure.

For example, the system or the platform (208) may include one or more processor(s) (302). The one or more processor(s) (302) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (302) may be configured to fetch and execute computer-readable instructions stored in a memory (304) of the system (208). The memory (304) may be configured to store one or more computer-readable instructions or routines in a non-transitory computer readable storage medium, which may be fetched and executed to create or share data packets over a network service. The memory (304) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (208) may include an interface(s) (306). The interface(s) (306) may comprise a variety of interfaces, for example, interfaces for data input and output devices, referred to as input/output (I/O) devices, storage devices, and the like. The interface(s) (306) may facilitate communication for the system (208). The interface(s) (306) may also provide a communication pathway for one or more components of the system (208). Examples of such components include, but are not limited to, processing unit/engine(s) (308) and a database (310).

The processing unit/engine(s) (308) may be implemented as a combination of hardware and programming (for example, programmable instructions) to implement one or more functionalities of the processing engine(s) (308). In examples described herein, such combinations of hardware and programming may be implemented in several different ways. For example, the programming for the processing engine(s) (308) may be processor-executable instructions stored on a non-transitory machine-readable storage medium and the hardware for the processing engine(s) (308) may comprise a processing resource (for example, one or more processors), to execute such instructions. In the present examples, the machine-readable storage medium may store instructions that, when executed by the processing resource, implement the processing engine(s) (308). In such examples, the system (208) may include the machine-readable storage medium storing the instructions and the processing resource to execute the instructions, or the machine-readable storage medium may be separate but accessible to the system (208) and the processing resource. In other examples, the processing engine(s) (308) may be implemented by electronic circuitry. In an aspect, the database (310) may comprise data that may be either stored or generated as a result of functionalities implemented by any of the components of the processor (302) or the processing engines (308).

In an embodiment, the processing engine (308) may include one or more units/engines such as, but not limited to, a connectivity management unit (312), a device management unit (314), a report and analytics unit (316), a security and compliance unit (318) and other unit(s) (320).

Referring to FIG. 3, the database (310) may store data related to a VIN, authentication, geo-fence boundary, various toll stations and their respective fee, contact details of a registered user such as, but not limited to, phone number, email address, etc., bank account associated with the registered user from which the toll fee may have to be deducted, etc.

By way of example but not limitation, the one or more processor(s) (302) may detect a vehicle entering a geo-fence boundary associated with a toll station or toll plaza, authenticate the vehicle based on the VIN, send an alert to the user/driver of the vehicle upon the vehicle entering the geo-fence, deduct the toll fee from the registered bank account when the vehicle exits the toll boundary. Further, in an embodiment, the one or more processor(s) (302) may detect the entry or exit of the vehicle based on a connection with an OBD device in the vehicle. In some embodiments, the OBD device may communicate with a base station or an access point which may further be communicated to the processor (302) through the connectivity management unit (312). In some embodiments, the device management unit (314) may manage the data to be obtained from the OBD device and may also enable turning on/off the OBD device. In some embodiments, the report and analytics unit (316) may obtain GPS data from the OBD device to determine if the vehicle has entered the toll station or not or may use the GPS data to alert the vehicle about an upcoming toll station.

Referring to FIG. 3, the security and compliance unit (318) may assist the processor (302) in authenticating the vehicle, i.e., whether VIN of the vehicle is registered with the database (310) and whether a bank account is registered with the associated VIN for deducting toll fee.

A person of ordinary skill in the art will appreciate that the exemplary block diagram (300) may be modular and flexible to accommodate any kind of changes in the system (208).

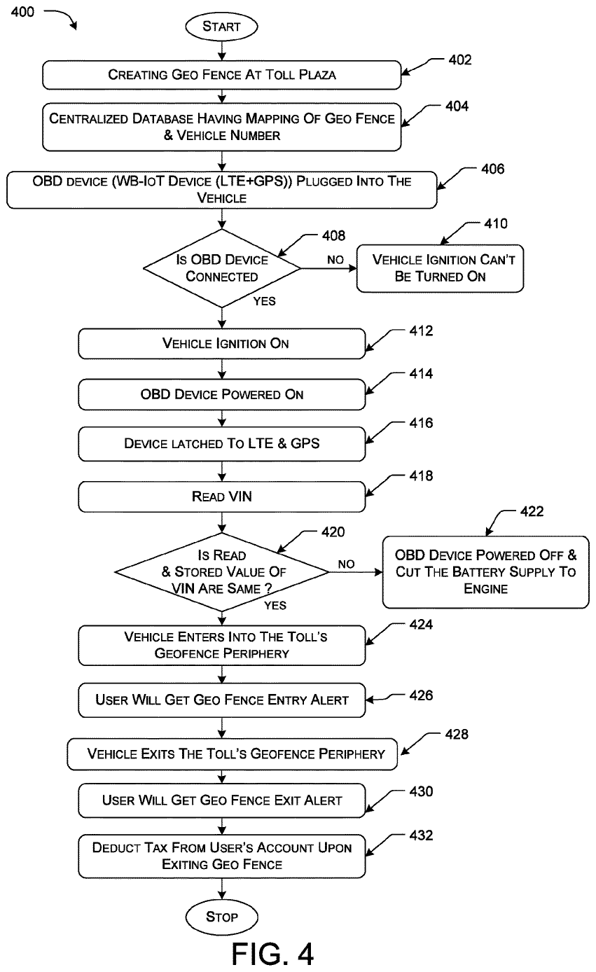

FIG. 4 illustrates an exemplary flow chart of a method (400) for automated toll and tax deduction, in accordance with an embodiment of the present disclosure. In some embodiments, the method (400) may be implemented at system/platform (208) of FIG. 2.

Referring to FIG. 4, the method (400) may include, at step 402, creating a geo-fence around a toll plaza. The method (400) may further include, at step 404, mapping the geo-fence details with a vehicle identify number or a vehicle number in a centralized database. Further, the method (400) may include, at step 406, plugging an OBD device into the vehicle (120) as shown in FIG. 1. In some embodiments, the OBD device may include a wideband IoT device capable of connecting with GPS and any communication network, such as, without limitations, 2G/3G/4G/5G/6G or any future generation network. The method (400) may further include, at step 408, checking if the OBD device is plugged into the vehicle or is operatively connected with the vehicle (120). If the OBD device is connected, the method may include, at step 412, turning ON the vehicle ignition. On the other hand, if the OBD device is not connected, the method may include, at step 410, preventing the turning ON of the vehicle ignition.

Referring to FIG. 4, upon turning ON the vehicle ignition, the method (400) may include, at step 414, powering ON the OBD device. Further, the method (400) may include, at step 416, latching the OBD device to the GPS and communication system system to enable detecting a vehicle's current location and to send alert messages when the vehicle (120) enters the geo-fence around the toll plaza. The method (400) may further include, at step 418, reading the VIN associated with the vehicle (120). The method (400) may include, at step 420, determining if the read VIN is matching with the stored VIN value. If the read value does not match with the stored value, the method (400) may include, at step 422, powering off the OBD device and cutting the battery supply to the engine. On the other hand, if the read value matches with the stored VIN value, the method (400) may include, at step 424, allowing the entry of the vehicle (120) into the geo-fence periphery. In some embodiments, the vehicle (120) may enter the geo-fence from a first side of a toll station. Further, the method (400) may include, at step 426, sending a first message to a user device associated with the vehicle (120) to alert the registered user or the driver of the vehicle (120) that the vehicle (120) has entered the geo-fence associated with the toll station. The method (400) may further include, at step 428, the vehicle (120) exiting the geofence. The method (400) may include, at step 430, sending a second message to the user device associated with the vehicle (120) to alert the registered user or the driver of the vehicle (120) that the vehicle (120) has exit the geo-fence associated with the toll station. Further, the method (400) may include, at step 432, deducting a toll fee for the vehicle (120) from the bank account registered with vehicle (120) after the vehicle (120) exits the geo-fence. In some embodiments, the toll fee may also be deducted from a third-party wallet resisted with a particular vehicle. Further, a third message may be sent to the user device associated with the vehicle (120) to alert the driver/user that the toll fee is deducted from the registered bank account.

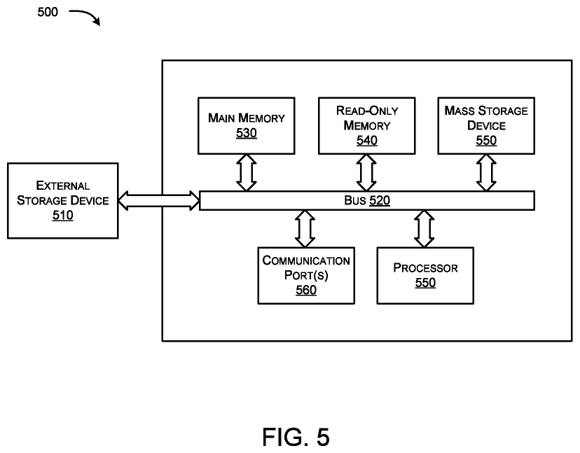

FIG. 5 illustrates an exemplary computer system (500) in which or with which embodiments of the present disclosure may be utilized.

As shown in FIG. 5, the computer system (500) may include an external storage device (510), a bus (520), a main memory (530), a read-only memory (540), a mass storage device (550), communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (560) may be chosen depending on a network, such a Local Area Network (LAN), Wide Area Network (WAN), or any network to which the computer system (500) connects. The main memory (530) may be random access memory (RAM), or any other dynamic storage device commonly known in the art. The read-only memory (540) may be any static storage device(s) including, but not limited to, a Programmable Read Only Memory (PROM) chips for storing static information e.g., start-up or basic input/output system (BIOS) instructions for the processor (570). The mass storage device (550) may be any current or future mass storage solution, which may be used to store information and/or instructions.

The bus (520) communicatively couples the processor (570) with the other memory, storage, and communication blocks. The bus (520) can be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (570) to the computer system (500).

Optionally, operator and administrative interfaces, e.g., a display, keyboard, and a cursor control device, may also be coupled to the bus (520) to support direct operator interaction with the computer system (500). Other operator and administrative interfaces may be provided through network connections connected through the communication port(s) (560). In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure enables a hassle-free toll collection process with digitization and transformation of existing toll collection methods.

The present disclosure enables authentication of a vehicle with an on-board diagnostic (OBD) device.

The present disclosure provides a system and a method for authentication and secured mechanism to inform a regulatory authority about the toll tax collection along with user information associated with the vehicle.

We claim:

1. An automated system (208) for vehicle toll and tax deduction, said system (208) comprising:
one or more processors (302); and
a memory (304) operatively coupled to the one or more processors (302), wherein the memory (304) comprises processor-executable instructions, which on execution, cause the one or more processors (302) to:
create a geo-fence (118) with a pre-defined radius around a toll station;
authenticate a vehicle (120) based on the vehicle (120) moving towards the geo-fence (118) from a first side of the toll station;
allow the vehicle (120) to enter the geo-fence (118) from the first side of the toll station based on a successful authentication of the vehicle (120); and
automatically deduct a toll fee based on the vehicle (120) exiting the geo-fence (118) from a second side of the toll station.

2. The system (208) as claimed in claim 1, wherein the memory (304) comprises processor-executable instructions, which on execution, cause the one or more processors (302) to:
obtain data from an on-board diagnostic (OBD) device connected to the vehicle (120) for communicating with a cellular network access point (110) and a global positioning system (GPS) network (112), detection, and authentication of the vehicle (120).

3. The system (208) as claimed in claim 2, wherein the OBD device is pre-fitted with the vehicle (120).

4. The system (208) as claimed in claim 2, wherein the OBD device is retrofitted with the vehicle (120).

5. The system (208) as claimed in claim 2, wherein the OBD device comprises a subscriber identity module (SIM) card to enable the OBD device to communicate with the cellular network access point (110).

6. The system (208) as claimed in claim 2, wherein the data obtained from the OBD device comprises GPS data.

7. The system (208) as claimed in claim 6, wherein the memory (304) comprises processor-executable instructions, which on execution, cause the one or more processors (302) to
report the obtained GPS data to an application server (210) to enable mapping of the GPS data with data associated with the created geo-fence (118) to generate the toll fee.

8. The system (208) as claimed in claim 1, wherein the memory (304) comprises processor-executable instructions, which on execution, cause the one or more processors (302) to:
authenticate the vehicle (120) based on a vehicle identification number (VIN) and an international mobile equipment identity (IMEI) number.

9. The system (208) as claimed in claim 1, wherein the memory (304) comprises processor-executable instructions, which on execution, cause the one or more processors (302) to:
send a first alert message to a user device associated with the vehicle (120) based on the vehicle (120) entering the geo-fence (118); and
send a second alert message to the user device associated with the vehicle (120) based on the vehicle (120) exiting the geo-fence (118).

10. The system (208) as claimed in claim 1, wherein the memory (304) comprises processor-executable instructions, which on execution, cause the one or more processors (302) to:
register at least one bank account associated with each vehicle (120) from which the toll fee is deducted; and
deduct the toll fee from the at least one registered bank account based on the vehicle (120) exiting the geo-fence (118).

11. The system (208) as claimed in claim 10, wherein the memory (304) comprises processor-executable instructions, which on execution, cause the one or more processors (302) to:
send a third alert message to the user device associated with the vehicle (120) based on deduction of the toll fee from the at least one registered account.

12. A method for automatically deducting vehicle toll and tax comprising:
creating, by one or more processors (302), a geo fence (118) with a pre-defined radius around a toll station;
authenticating, by the one or more processors (302), a vehicle (120) based on the vehicle (120) moving towards the geo fence (118) from a first side of the toll station;
allowing, by the one or more processors (302), the vehicle (120) to enter the geo fence (118) from the first side of the toll station; and
deducting, by the one or more processors (302), a toll fee automatically based on the vehicle (120) exiting the geofence (118) from a second side of the toll station.

13. The method as claimed in claim 12, comprising:
obtaining, by the one or more processors (302), data from an on-board diagnostic (OBD) device connected to the vehicle (120) for communicating with a cellular network access point (110) and a global positioning system (GPS) network (112), detection, and authentication of the vehicle (120).

14. The method as claimed in claim 12, comprising:
authenticating, by the one or more processors (302), the vehicle (120) based on a vehicle identification number (VIN) and an international mobile equipment identity (IMEI) number.

15. The method as claimed in claim 12, comprising:
sending, by the one or more processors (302), a first alert message to a user device associated with the vehicle (120) based on the vehicle (120) entering the geo fence (118); and
sending, by the one or more processors (302), a second alert message to the user device associated with the vehicle (120) based on the vehicle (120) exiting the geo fence (118).

16. The method as claimed in claim 12, comprising:
registering, by the one or more processors (302), at least one bank account associated with each vehicle (120) from which the toll fee is deducted; and
deducting, by the one or more processors (302), the toll fee from the registered bank account based on the vehicle (120) exiting the geo-fence (118).

17. The method as claimed in claim 16, comprising:
sending, by the one or more processors (302), a third alert message to the user device associated with the vehicle based on deducting the toll fee from the at least one registered account.

18. A user equipment (UE), comprising:
one or more processors communicatively coupled to a system (208), wherein the one or more processors are operatively coupled to a memory comprising processor-executable instructions, which on execution, cause the one or more processors to:
associate the UE with a vehicle (120);
send a geographical location of the vehicle (120) to the system (208) upon turning on of an ignition of the vehicle (120);
send a vehicle identity number to the system (208) for authentication;
receive a first message from the system (208), wherein the first message indicates that the vehicle (120) entered a geo-fence associated with a toll station;
receive a second message from the system (208), wherein the second message indicates that the vehicle (120) exit the geo-fence; and
receive a third message from the system (208), wherein the third message indicates deduction of a toll tax from an account registered with the vehicle (120).

19. A non-transitory computer readable medium that comprises one or more instructions stored thereupon that when executed by a processor causes the processor to:
create a geo fence (118) with a pre-defined radius around a toll station;
authenticate a vehicle (120) based on the vehicle (120) moving towards the geo fence (118) from a first side of the toll station;
allow the vehicle (120) to enter the geo fence (118) from a first side of the toll station based on the successful authentication of the vehicle (120); and
deduct a toll fee automatically based on the vehicle (120) exiting the geofence (118) from a second side of the toll station.
